(19) United States
(12) Patent Application Publication
(10) Pub. No.: US 2013/0061701 A1
(43) Pub. Date: Mar. 14, 2013

(54) TRANSMISSION FOR A VEHICLE

(71) Applicant: Michael WECHS, Sigmarszell (DE)

(72) Inventor: Michael WECHS, Sigmarszell (DE)

(73) Assignee: ZF FRIEDRICHSHAFEN AG, Friedrichshafen (DE)

(21) Appl. No.: 13/594,986

(22) Filed: Aug. 27, 2012

(30) Foreign Application Priority Data
Sep. 14, 2011 (DE) 10 2011 082 634.3

(51) Int. Cl. F16H 3/091

(52) U.S. Cl. 74/330

(57) ABSTRACT

A dual clutch transmission for a motor vehicle which comprises at least two part-transmissions each of which has at least one input shaft and an output shaft arranged as the drive output shaft of both part-transmissions. The at least one input shaft and the output shaft are arranged on a main axis and/or a secondary axis and at least one intermediate transmission with at least one countershaft is provided, the at least one countershaft is designed as the secondary axis relative to the main axis, and at least one of the input shafts can be connected to the output shaft by at least two gearwheel planes and/or by way of at least one shifting element. A plurality of shifting elements N in number are provided with N being an integer larger than or equal to two such that N-1 shifting elements are arranged on the main axis.

This application claims priority from German patent application serial no. 10 2011 082 634.3 filed Sep. 14, 2011.

### FIELD OF INVENTION

The invention concerns a transmission, in particular a dual clutch transmission for a motor vehicle, comprising at least two part-transmissions, each part-transmission having at least one input shaft and such that an output shaft is arranged as the drive output shaft of both part-transmissions, wherein at least one of the input shafts and the drive output shaft are positioned on a main axis and wherein at least one intermediate gear is arranged with at least one countershaft, such that the at least one countershaft is arranged on a secondary axis adjacent to the main axis and such that the at least one input shaft can be connected to the output shaft by means of at least two gearwheel planes and/or at least one shifting element.

### BACKGROUND OF THE INVENTION

Such transmissions for a motor vehicle are, inter alia, designed as so-termed dual clutch transmissions, in which the input shafts of the two part-transmissions can each be connected by way of an associated shift-under-load (powershift) element to a drive input, for example an internal combustion engine or an electric motor, so that in this case the two powershift elements are combined in the form of a dual clutch. The gear stages that can be obtained with such a transmission are then divided in alternation between the two part-transmissions, for example so that one part-transmission produces the odd-numbered gears and the corresponding, other part-gear produces the even-numbered gears. It is also known to produce the individual gears by one or more gearwheel stages or planes, each having different gear ratios. By means of corresponding shifting elements these can be engaged in the force flow or torque flow between the drive input and the drive output, so that a corresponding, desired gear ratio between the input and output of the transmission can in each case be obtained.

By dividing the gears in alternation between the two part-transmissions it is made possible, when driving in a gear associated with one part-transmission, already to pre-select a next gear in the respective other part-transmission by appropriate actuation of the shifting mechanisms, so enabling an eventual change to the next gear to be carried out by opening the powershift element of the one part-transmission and shortly thereafter closing the powershift element of the other part-transmission. In this way the gears or gear steps of the transmission can be shifted under load, which improves the acceleration performance of the motor vehicle owing to a gear change essentially free from traction force interruption, and makes shifting processes more comfortable for a driver of the vehicle.

Such dual clutch transmissions can also be made with an intermediate transmission additional to the drive input and output, which enables a more compact structure in the axial direction.

DE 10 2006 054 281 A1 describes a motor vehicle with a transmission of this type in the form of a dual clutch transmission. In that case the dual clutch transmission comprises two part-transmissions each with an input shaft. By connecting the respective input shaft by means of an associated powershift element the two part-transmissions can be engaged in alternation in a force or torque flow from a drive input to a drive output, the input shaft of the first part-transmission being made as a central transmission shaft and the input shaft of the second part-transmission as a hollow shaft of the transmission. Furthermore an output shaft is provided, which is designed to be the drive output of both part-transmissions, so that rotational movement of the drive input can be transmitted via a plurality of gear ratio steps to the drive output, with the force and torque flow passing by way of an intermediate gear. In this case at least two gearwheel planes are engaged in the force and torque flow by actuating associated shifting elements, so that by a combination of the shifting element actuations and the force and torque flow passing via appropriate gearwheel planes a plurality of gear ratio stages can be obtained. In addition it is also possible to transmit the rotation of the drive input to an output shaft of the drive output without gear transformation, by actuating appropriate shifting elements.

### SUMMARY OF THE INVENTION

An objective of the present invention is to make available a transmission for a motor vehicle, which enables flexible power division, improved powershift ability and/or improved hybridization ability. Moreover, an objective of this invention can be to provide a transmission for a motor vehicle, which is simpler and cheaper to produce and at the same time enables the reliable transmission of torques between the drive input and the drive output. Furthermore, an objective of the present invention can be to indicate an alternative transmission for a motor vehicle.

The present invention achieves the objectives with a transmission, in particular a dual clutch transmission for a motor vehicle, comprising at least two part-transmissions, wherein each of the part-transmissions has at least one input shaft and wherein an output shaft is provided as the drive output shaft for both part-transmissions, such that at least one of the input shafts is arranged on a main axis and the drive output shaft is arranged on the main axis and/or on the secondary axis, and wherein at least one intermediate gear is arranged with at least one countershaft, the at least one countershaft having an axis parallel to the main axis, and wherein the at least one input shaft can be connected to the output shaft by means of at least two gearwheel planes and/or at least one shifting element, in that a plurality of shifting elements N in number are provided, N being an integer larger than or equal to 2 and at least N-1 shifting elements are arranged on the main axis.

The secondary axis is the axis of the intermediate transmission.

One of the advantages achieved by this is that by far most of the shifting elements, in particular all of them, are arranged on the main axis which functions as the central axis of the transmission. This enables a comfortable and flexible power division by means of the intermediate transmission. Moreover, in this way larger torques can be transmitted from the drive input to the drive output side. Furthermore, in this way a mechanical spread can be reduced by turning the first forward gear of the transmission. And finally, the transmission has better powershift ability and good hybridization ability, since an electric machine can be coupled to the transmission in a more simple way.

The terms “gearwheel stage” or “gearwheel plane” are preferably understood, in the description and particularly in the claims, to mean in essence two transmission elements that co-operate with one another to transmit torques from one transmission element to the other transmission element, which preferably provide in the transmission a step-down or step-up ratio in particular for the shafts that co-operate with the transmission elements.

In the description and particularly in the claims, the term “shifting element” is preferably understood to mean a device with at least an open and a closed condition, such that in the open condition the device cannot transmit any torque whereas in the closed condition the device can transmit a torque between two devices that co-operate with the shifting element.

In the description and particularly in the claims, the term “shifting mechanism” is preferably understood to mean at least one shifting element and at least one shifting-element-actuating device for actuating the at least one shifting element.

In the description and particularly in the claims, the term “transmission element” is preferably understood to mean a device by which torque can be transmitted. In this context transmission elements can preferably be in the form of wheels, preferably gearwheels and in particular spur gears, conical gears, worm gears or the like.

Further advantageous embodiments, features and advantages of the invention are described in the subordinate claims.

Expediently, an intermediate shaft is arranged between at least one of the input shafts and the output shaft, which can be connected by means of at least two shifting elements to one of the input shafts and/or to the output shaft and/or to the countershaft. An advantage of this is that the flexibility of the transmission is substantially increased, since in a simple and reliable manner different gearwheel planes can be connected for the provision of gear steps. In this way the number of gear stages can be increased without much additional cost.

The intermediate shaft can in particular be arranged on the main axis.

Advantageously, the at least two input shafts are arranged coaxially with one another. An advantage of this is that they can be arranged relative to one another in a space-saving manner. Likewise, a plurality of countershafts can be provided thereby, so that numerous gears or gear stages can be obtained with the transmission.

Advantageously, the secondary axis is arranged parallel to the main axis. This enables a simple transmission of torques, in particular by means of appropriate gearwheel planes between the secondary axis and the main axis. In this way torques can be transmitted, for example by means of correspondingly arranged transmission elements, especially in the form of spur gears or shafts on the main and secondary axes. At the same time the structural space occupied is not much larger, thanks to the corresponding arrangement of the main and secondary axes.

Expediently, at least one gearwheel plane is in the form of a spur gear stage. This provides a simple and exceptionally inexpensive gearwheel plane, in particular for producing a step-down or step-up stage.

Advantageously, at least two of the shifting elements are combined in a shifting mechanism. In this way the shifting elements can for example be served or actuated by means of a single actuating device for the shifting mechanism, so that on the one hand the space occupied by the shifting elements is reduced and on the other hand, too, fewer components are needed, so production costs are lower.

Expediently, at least one transmission element of one of the gearwheel planes on at least one input shaft can be coupled by means of at least one shifting element with at least one of the input shafts. In this way for example, if transmission elements of more than one gearwheel plane can be coupled with at least one of the input shafts, a number of possible gears or gear stages can be provided without needing a large number of components for this.

Advantageously, at least two gearwheel planes can be coupled to the intermediate shaft by means of at least one shifting element. In this way the number of gears or gear stages that can be obtained with the transmission can be increased still more without substantially increasing the space occupied and without incurring high costs.

Expediently, one of the gearwheel planes is designed as an output constant.

This has the advantage of enabling reliable force and torque transmission from the drive input by way of at least one input shaft, through the transmission, to the output shaft for the drive output. When the gearwheel plane is made as an output constant in each case the transmission elements are arranged fixed on respective shafts.

Preferably, in each case the transmission elements of the gearwheel plane made as an output constant are connected fixed to the output shaft and the countershaft, respectively.

Advantageously transmission elements, in particular gearwheels of at least one of the gearwheel planes are arranged fixed on at least one of the countershafts. One of the advantages achieved thereby is that the transmission elements together with the countershaft can be produced inexpensively, in particular by forming the transmission elements integrally with the countershaft.

Expediently at least two countershafts are provided, of which at least one countershaft is a solid shaft and at least one other countershaft is made as a hollow shaft. Thus two or more countershafts can be provided in a space-saving manner so that the transmission as a whole takes up exceptionally little fitting space. This allows the transmission to be fitted into the greatest variety of motor vehicles even when space is restricted. Accordingly, there is no need for elaborate and expensive adaptations for a particular type of vehicle.

Advantageously the transmission elements, in particular the gearwheels, of at least one of the gearwheel planes are arranged fixed to the hollow shaft. On the one hand this ensures exceptionally secure force and torque transmission by the transmission elements to the hollow shaft, and on the other hand it also enables inexpensive production since the hollow shaft and the transmission element can be combined integrally. The costs incurred for separate production of the hollow shaft and the transmission element, and also for the time taken to join the transmission element and the hollow shaft to one another, are eliminated.

Expediently, at least one gearwheel plane is designed as a reversing gear stage. Thus, by virtue of the at least one reversing gear stage the rotational direction of the output shaft can be reversed so that a reversing gear can be provided for a vehicle, which substantially increases flexibility with regard to the use of the transmission in various vehicles.

Advantageously, the reversing gear stage is arranged between two shifting elements, in particular on the intermediate shaft. In this way at least two reversing gear stages can be provided by the transmission, so that the transmission can be used flexibly in a variety of vehicles.

Expediently, the shifting element for actuating the reversing gear stage is arranged on the secondary axis. In this way the extension of the transmission along the main and secondary axis can be made shorter, since by moving the shifting element for the reversing gear stage onto the secondary axis, in particular onto the countershaft, the number of shifting elements on the main axis can be reduced and therefore also the overall extension of the transmission along the main axis and thus also the secondary axis.

Advantageously, for hybridization an electric machine is arranged on at least one transmission element of a gearwheel plane and/or a countershaft and/or an input shaft. In this way the transmission can also be used in hybrid vehicles in which both an electric machine and an internal combustion engine are designed to co-operate with the transmission for the transmission of forces to the drive input of the hybrid vehicle. In this case the at least one electric machine can be connected to at least one of the input, intermediate or output shafts or to at least one of the countershafts. The electric machine can also be connected to a transmission element in the form of a fixed wheel or a loose wheel of one of the gearwheel planes.

The electric machine can also be connected to an additional fixed wheel, i.e.

to a wheel connected fixed to one of the shafts of the transmission. In this case it is particularly advantageous to connect the electric machine to the transmission by means of at least one shifting element, particularly to a transmission element of a gearwheel plane. The advantage obtained with this first connection possibility is that it makes possible so-termed static charging and electric driving without drag losses in the transmission. On this, explicit reference is made to the disclosure content of DE 10 2010 030 569 A1: in that case a first input shaft can be coupled to a powershift element, while a second input shaft, which in particular is arranged coaxially with the first input shaft, is connected directly to a rotor of the electric machine for driving it. In this way two parallel force transmission branches can be coupled with one another on the input side.

A second possibility for connecting the electric machine to the transmission is enabled by arranging a planetary gearset in the transmission: in this case an internal combustion engine can be coupled to a first input shaft by a corresponding shifting element, particularly in the form of a separator clutch. The electric machine engages on the one hand with a second input shaft and with the first input shaft of the transmission by way of the planetary gearset. When the separator clutch is actuated, i.e. closed, the internal combustion engine is also coupled by the planetary gearset to the second input shaft. The planetary gearset, comprising a planetary gear, a ring gear, planetary gears and a planetary carrier, is designed to co-operate with the internal combustion engine and the electric machine in such manner that the planetary carrier engages with the second input shaft. The electric machine is coupled to the sun gear of the planetary gearset. Moreover, a further shifting element in the form of a bridging shifting element can be provided, which co-operates with the planetary gearset in such manner that when the bridging shifting element is actuated, a rotationally fixed connection is formed between the electric machine, the first input shaft and the second input shaft, while on the other hand, when the bridging shifting element is not actuated, i.e. open, the rotationally fixed connection between the electric machine and the first and second input shafts is not formed so that, in particular, there is no equality of speeds between the two input shafts.

If a further shifting element is arranged between the shifting element that serves to connect the internal combustion engine to the first input shaft and the bridging shifting element, then by means of this further shifting element, in particular in the form of a dual shifting element, both the aforesaid first connection possibility and the aforesaid second connection possibility can be implemented by actuating the further shifting element.

Expediently, the electric machine is arranged on one of the gearwheel planes located between two shifting elements. In this way a simple connection of the electric machine to the transmission and hence reliable force and torque transmission from the electric machine ultimately to the output shaft is made possible.

Advantageously, the N shifting elements and/or the at least two gearwheel planes are arranged in such manner that at least six forward gears and especially seven forward gears, and at least two reverse gears, can be obtained with the transmission. The advantage of this is that a sufficient number of forward and reverse gears can be provided for numerous vehicles, in particular both for passenger motor vehicles and for trucks.

Expediently, shifting element actuating mechanisms are provided for actuating the N shifting elements, such that the number of shifting element actuating mechanisms is at least _{└}N/2_{┘}+1 and in particular equal to _{└}N/2_{┘}+1. The symbol _{└} _{┘} J denotes the Gauss-bracket function. This has the advantage that in particular shifting elements can be combined in shifting devices and these can be actuated by means of the smallest possible number of shifting element actuating mechanisms, which on the one hand saves space and on the other hand is less expensive. The number of actuating mechanisms, which is a function of the number N of shifting elements, is obtained by halving the number N of shifting elements, rounding the figure so obtained down to the next-lower whole number, and adding 1, so that again a whole number is obtained.

Further important features and advantages of the invention emerge from the subordinate claims, from the drawings and from the associated description of figures that refer to the drawings.

It is understood that the features mentioned above and those still to be explained below can be used not only in the combinations indicated, but also in other combinations or in isolation, without going beyond the scope of the present invention.

Preferred designs and embodiments of the invention are shown in the drawings and explained below in more detail. The same indexes refer to the same, or similar, or functionally equivalent components or elements.

### BRIEF DESCRIPTION OF THE DRAWINGS

The drawings show, in each case schematically:

FIG. 1: A transmission according to a first embodiment of the present invention;

FIG. 2: A transmission according to a second embodiment of the present invention;

FIG. 3a: A shifting matrix for a transmission according to the first embodiment, shown in FIG. 1;

FIG. 3b: A shifting matrix for a transmission according to the second embodiment, shown in FIG. 2;

FIG. 4a: A transmission according to a third embodiment of the present invention;

FIG. 4b: A transmission according to a fourth embodiment of the present invention;

FIG. 5a: A transmission according to a fifth embodiment of the present invention;

FIG. 5b: A transmission according to a sixth embodiment of the present invention; and

FIG. 6: A transmission according to a seventh embodiment of the present invention.

### DETAILED DESCRIPTION OF THE PREFERRED EMBODIMENTS

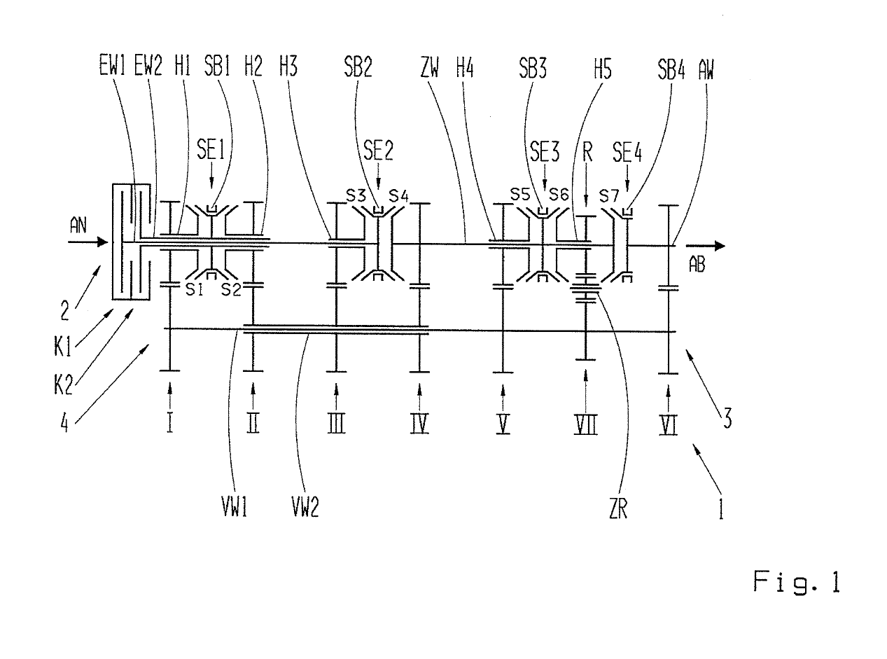

FIG. 1 shows a first embodiment of a transmission according to the present invention.

In FIG. 1 the index 1 denotes a transmission in the form of a dual clutch transmission. The dual clutch transmission 1 has two powershift elements in the form of clutches K1, K2. By means of the dual clutch K1, K2 the drive input side AN can be coupled to the drive output side AB for the transmission of torques. For this purpose the first clutch K1 is connected to a first input shaft EW1 and the second clutch K2 is connected to a second input shaft EW2. In this case the second input shaft EW2 is made as a hollow shaft whereas the first input shaft EW1 is a solid shaft. The two input shafts EW1, EW2 are arranged coaxially to one another. In addition the transmission 1 has a main axis 2 and, along the torque and force flow downstream from the drive input beginning from the two clutches K1, K2, first a first gearwheel plane I, a first shifting element S1, a second shifting element S2 and a second gearwheel plane II, and then a third gearwheel plane III, a third shifting element S3, a fourth gearwheel plane IV, a fourth shifting element S4, a fifth gearwheel plane V, a fifth shifting element S5, a sixth shifting element S6, a seventh gearwheel plane VII in the form of a reversing gear stage, a seventh shifting element S7 and a sixth gearwheel plane VI. Each of the gearwheel planes I, II, III, IV, V, VI, and VII comprise transmission elements, in each case connected to shafts of the transmission 1. In this case the gearwheel plane VI is connected to an output shaft AW of the drive output AB.

Parallel to the main axis 2 is arranged an axis 3 of an intermediate transmission 4, a so-termed secondary axis. The intermediate transmission 4, comprises a countershaft VW1 in the form of a solid shaft and a second countershaft VW2 arranged over part of the first countershaft VW1 and made as a hollow shaft,. On the countershaft VW1 are provided transmission elements for the gearwheel planes I, V, VI, and VII for the transmission of torques. The second countershaft VW2 has transmission elements for the gearwheel planes II, III, and IV. Between the secondary axis 3 and the main axis 2 the gearwheel plane VII, in the form of the reversing gear stage, has an intermediate gearwheel for reversing the rotation direction, so that with the same rotational direction of one of the input shafts a reverse rotational direction is enabled by means of the output shaft for the provision of at least one reversing gear.

Below, the shifting elements S1 to S7 will now be described: the shifting element S1, when actuated, produces a transmission of torques from the second input shaft EW2 and a first hollow shaft H1 which is arranged on the outside of the second input shaft EW2 and coaxially with it. On the first hollow shaft H1 is arranged a transmission element for transmitting torques from the main axis 2 to the secondary axis 3. As explained earlier, this transmission element together with a correspondingly made transmission element on the secondary axis 3, form the first gearwheel plane I. The second shifting element S2 forms a connection between the second input shaft EW2 and a second hollow shaft H2. On the second hollow shaft H2 there is also arranged a transmission element, which co-operates with a transmission element on the second countershaft VW2 to transmit force and torques between the two shafts EW2 and VW2. The two transmission elements form the second gearwheel plane II. Furthermore, the two shifting elements S1, S2 are combined in a common first shifting mechanism SE1 and can be actuated by means of a common shifting mechanism actuating element SB1, i.e. brought to an open or a closed condition. The first input shaft EW1 is also connected to the third shifting element S3. Besides, the third shifting element S3 is also connected to a third hollow shaft H3 which enables a transmission element to transmit torques from the first input shaft EW1 to the second countershaft VW2. For this, corresponding transmission elements of the second countershaft VW2 co-operate with the transmission element on the third hollow shaft H3. These form the third gearwheel plane III.

The fourth shifting element S4 is connected to an intermediate shaft ZW. The intermediate shaft ZW is arranged along the main axis 2 between the input shafts EW1, EW2 and the output shaft AW. On the intermediate shaft ZW is arranged a transmission element for transmitting torques from the intermediate shaft ZW to the second countershaft VW2. On the second countershaft VW2 is arranged a corresponding transmission element which co-operates with the transmission element on the intermediate shaft ZW to transmit torques. The two transmission elements on the intermediate shaft ZW and on the second countershaft VW2 form the gearwheel plane IV.

The intermediate shaft ZW is also connected to a fifth shifting element S5. On the outside of the intermediate shaft ZW made as a solid shaft, is arranged a fourth hollow shaft H4 which has a transmission element for the transmission of torques from the fourth hollow shaft H4 to the first countershaft VW1. For that purpose the countershaft VW1 has on it a corresponding transmission element, and the two transmission elements form the gearwheel plane V.

The intermediate shaft ZW is also connected to a sixth shifting element S6. On the outside of the intermediate shaft ZW is arranged a fifth hollow shaft H5. This fifth hollow shaft H5 has a transmission element which co-operates with an intermediate wheel ZR, and a transmission element on the first countershaft VW1 and the fifth hollow shaft H5, respectively, form the seventh gearwheel plane VII in the form of a reversing gear stage.

The intermediate shaft ZW is, further, connected to a seventh shifting element S7. The shifting element S7 is connected to the output shaft AW of the drive output AB of the transmission 1. The output shaft AW has a transmission element which co-operates with a transmission element on the first countershaft VW1. These two transmission elements form the sixth gearwheel plane VI. As shown in FIG. 1, the sixth gearwheel plane VI is in the form of an output constant.

Taken together, the third shifting element S3 and the fourth shifting element S4 are combined in a second shifting mechanism SE2, which can be actuated by means of a common, second shifting element actuating device SB2. The same also applies, correspondingly, to the fifth shifting element S5 and the sixth shifting element S6, which are combined in a shifting mechanism SE3. The two shifting elements S5, S6 can be actuated correspondingly by means of a shifting element actuating device SB3. The shifting mechanism SE4 comprises only the shifting element S7, which can be actuated by means of a fourth shifting element actuating device SB4. In this context the shifting element actuating devices SB1, SB2, SB3 can be made as dual synchronizers.

In this case the transmission elements can be arranged both fixed and loosely on the respective shaft, in particular on the input shafts EW1, EW2 and/or on at least one of the countershafts VW1, VW2 and/or on the intermediate shaft ZW. The transmission elements can in particular be in the form of gearwheels, especially spur gears, so that the gearwheel planes I, II, III, IV, V, VI, and VII constitute spur gear stages. To obtain various forward and reverse gears, i.e. various gear ratios, the spur gear stages and in particular their gearwheels can accordingly have various ratios in order to provide different forward and/or reverse gears.

The shifting element actuating devices SB1, SB2, SB3 can be designed in the form of dual synchronizers and the shifting element actuating device SB4 in the form of a single synchronizer. In total, the transmission 1 shown in FIG. 1 has two input shafts EW1, EW2 in the form of a solid and a hollow shaft, positioned along the main axis 2. Along the secondary axis 3 parallel to the main axis 2 are arranged two countershafts VW1, VW2, one made as a solid shaft and one coaxial with it and made as a hollow shaft. In addition the intermediate shaft ZW and the output shaft AW are made as solid shafts and are arranged coaxially with the main axis 2. The transmission 1 in FIG. 1 has seven gearwheel planes I to VII, of which the gearwheel plane VII is designed as a reversing gear stage. All the gearwheel planes I to VII are made in particular as spur gear stages with discrete gear ratios. Each of the gearwheels planes I to VI has two transmission elements, specifically in the form of gearwheels, whereas the reversing gear stage VII comprises an additional gearwheel in the form of an intermediate gear ZR. Thus, a total of fifteen transmission elements are provided, specifically in the form of gearwheels.

The gearwheel planes I to III can be coupled by means of the shifting elements S1, S2, S3 to one of the input shafts EW1, EW2. The fifth and seventh gearwheel planes V, VII can be coupled by means of the shifting elements S5, S6 to the intermediate shaft ZW. The gearwheel plane VI is connected fixed both to the output shaft AW and also to the countershaft VW1. Thus, the gearwheel plane VI is made as an output constant. The input shaft EW1, which is made as a solid shaft, can be coupled by the shifting elements S3, S4 to the intermediate shaft ZW. In turn, the intermediate shaft ZW can be coupled directly by means of the shifting element S7 to the output shaft AW. The transmission elements of the gearwheel planes II, III and IV on the secondary axis 3 are connected fixed on the countershaft VW2, which is arranged co-axially with the first countershaft VW1 and is made as a hollow shaft.

In all, with the embodiment of the transmission 1 shown in FIG. 1 at least six forward gears and at least two reverse gears can be obtained.

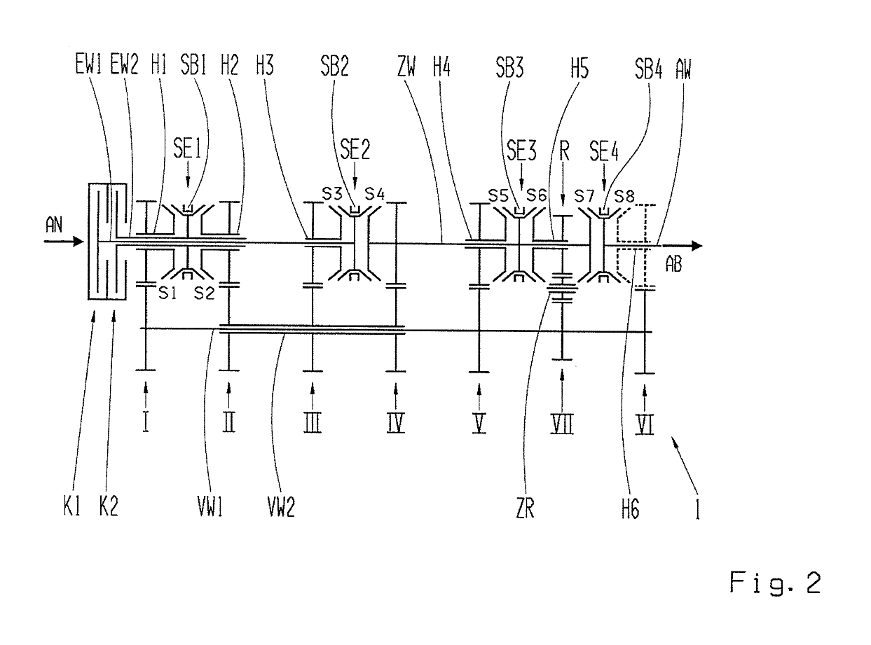

FIG. 2 shows a second embodiment of a transmission according to the present invention.

FIG. 2 shows a transmission 1 which is essentially like that shown in FIG. 1. The difference from FIG. 1 is that this transmission has a modified sixth gearwheel plane VI. In this case an eighth shifting element S8 is provided, which is combined with the shifting element S7 in a shifting mechanism SE4. To actuate the shifting elements S7, S8 a shifting element actuating device SB4 in the form of a dual synchronizer is provided. The shifting element S8 is connected to a sixth hollow shaft H6, which is arranged coaxially with the output shaft AW. The shifting element S8 forms a torque-transmitting connection between the hollow shaft H6 and the output shaft AW. The hollow shaft H6 has a transmission element, which co-operates with the corresponding transmission element of the gearwheel plane VI on the countershaft VW1, so that from the countershaft VW1 a torque is transmitted to the sixth gearwheel plane VI when the shifting element S8 is closed, i.e. actuated, and by way of the transmission elements from the hollow shaft H6 to the output shaft AW.

Thus, by means of the second embodiment of the transmission 1 shown in FIG. 2 at least seven forward gear stages and at least three reverse gear stages can be obtained.

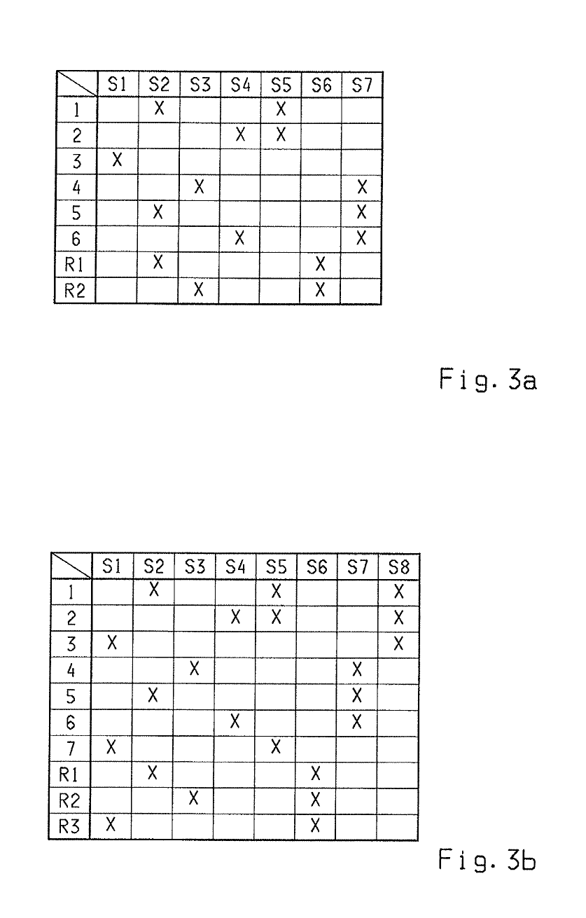

FIG. 3a shows a shifting matrix for a transmission according to the first embodiment shown in FIG. 1. The horizontal rows contain a respective column for each of the shifting elements S1 to S7. Perpendicular to these and downward are first the six forward gear steps, denoted by the numbers 1 to 6, and the two reversing gear steps denoted as R1 and R2. The cells left empty in the matrix, for example in the case of forward gear 1 those corresponding to the shifting elements S1, S3, S4, S6 and S7, indicate that those shifting elements are open, i.e. that the shifting element concerned transmits no force or no torque from the respective shafts connected to the shifting elements.

To obtain the first gear by means of the transmission 1, the shifting elements S1, S3, S4, S6 and S7 are opened and the shifting elements S2, S5 are closed. To obtain the second gear the shifting elements S1, S2, S3, S6, S7 are opened and the shifting elements S4, S5 are closed. For the third gear the shifting elements S2, S3, S4, S5, S6, S7 are opened and the shifting element S1 is closed. For the fourth gear the shifting elements S1, S2, S4, S5, S6 are opened and the shifting elements S3, S7 are closed. To obtain the fifth gear, the shifting elements S1, S3, S4, S5, S6 are opened and the shifting elements S2, S7 are closed. For the sixth gear the shifting elements S1, S2, S3, S5, S6 are opened and the shifting elements S4, S7 are closed. To obtain the first reverse gear the shifting elements S1, S3, S4, S5, S7 are opened and the shifting elements S2, S6 are closed. For the second reverse gear the shifting element S1, S2, S4, S5, S7 are opened and the shifting elements S3, S6 are closed. In this way six forward gears and two reverse gears can be obtained by means of the transmission 1 according to FIG. 1.

FIG. 3b shows a shifting matrix for a transmission according to the second embodiment of the present invention, shown in FIG. 2.

Here again, cells of the shifting matrix left empty denote a corresponding shifting element that is open in the gear concerned, while those marked with a cross denote a shifting element that is closed in the gear concerned. To obtain the first gear, as shown in FIG. 3b the shifting elements S1, S3, S4, S6, S7 are opened and the shifting elements S2, S5, S8 are closed. For the second gear the shifting elements S1, S2, S3, S6, S7 are opened and the shifting elements S4, S5, S8 are closed. For the third gear the shifting elements S2, S3, S4, S5, S6, S7 are opened and the shifting elements S1, S8 are closed. For the fourth gear the shifting elements S1, S2, S4, S5, S6, S8 are opened and the shifting elements S3, S7 are closed. For the fifth gear the shifting elements S1, S3, S4, S5, S6, S8 are opened and the shifting elements S2, S7 are closed For the sixth gear the shifting elements S1, S2, S3, S5, S6, S8 are opened and the shifting elements S4, S7 are closed. For the seventh gear the shifting elements S2, S3, S4, S6, S7, S8 are opened and the shifting elements S1, S5 are closed. To obtain the first reverse gear the shifting elements S1, S3, S4, S5, S7, S8 are opened and the shifting elements S2, S6 are closed. For the second reverse gear shifting elements S1, S2, S4, S5, S7, S8 are opened and the shifting elements S3, S6 are closed. And for the third reverse gear the shifting elements S2, S3, S4, S5, S7, S8 are opened and the shifting elements S1, S6 are closed. In this way seven forward gears and three reverse gears can be obtained by means of the transmission shown in FIG. 2.

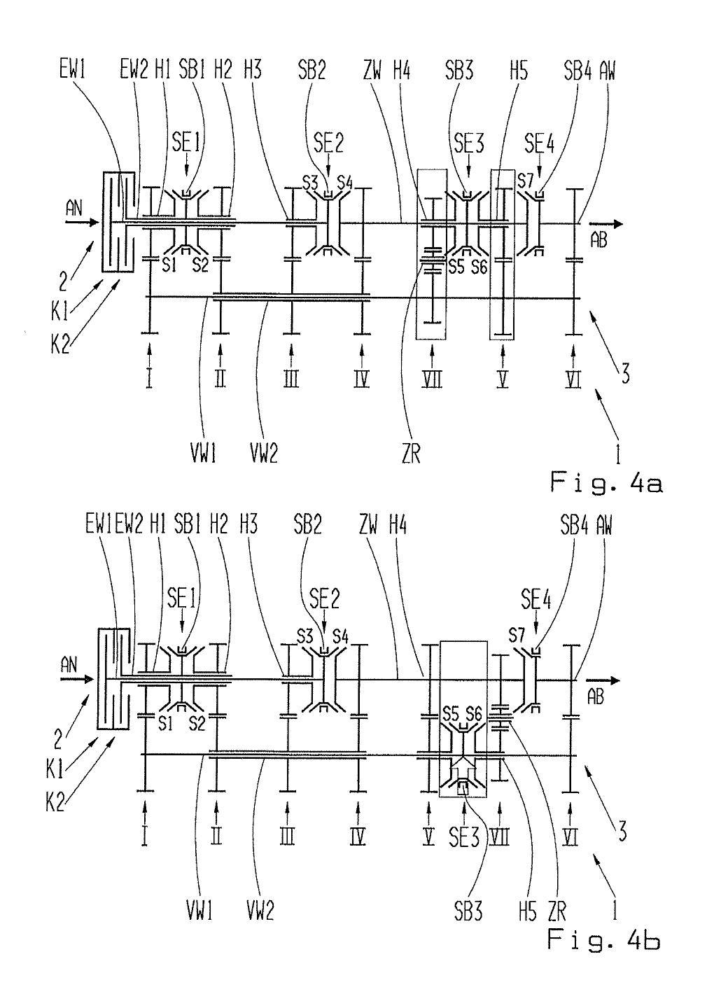

FIG. 4a shows a transmission according to a third embodiment of the present invention.

FIG. 4a shows a transmission 1 essentially like that of FIG. 1.The difference from the transmission 1 of FIG. 1 is that in their arrangement in the transmission along the main axis 2 and the secondary axis 3, the positions of the fifth and seventh gearwheel planes V, VII have been swapped. The transmission element of the reversing gear stage VII along the main axis 2 is connected to the fourth hollow shaft H4, which in turn is connected to the shifting element S5. The transmission element along the main axis 2 of the fifth gearwheel plane V is connected to the fifth hollow shaft H5, which in turn is connected to the shifting element S6.

FIG. 4b shows a fourth embodiment of a transmission according to the present invention.

FIG. 4b shows a transmission 1 essentially like that of FIG. 1. The difference from the transmission 1 of FIG. 1 is that the third shifting mechanism SE3 is now arranged on the secondary axis 3 instead of on the main axis 2. Thus, the intermediate shaft ZW on the main axis 2 extends from the fourth shifting element S4 to the seventh shifting element S7. Accordingly, along the intermediate shaft ZW are arranged three transmission elements corresponding to the gearwheel planes IV, V and VII. The shifting element S5 is connected on one side to the first countershaft VW1 and on the other side to the fourth hollow shaft H4, which is now arranged coaxially with the first countershaft VW1. The fourth hollow shaft H4 has a transmission element in order to form the fifth gearwheel plane V which a corresponding transmission element on the intermediate shaft ZW. The shifting element S6 is connected to the fifth hollow shaft H5, which is arranged coaxially with the first countershaft VW1. The shifting element S6 is also connected to the first countershaft VW1. The fifth hollow shaft H5 has a transmission element which, with a corresponding transmission element on the intermediate shaft ZW and with the interposition of an intermediate gearwheel ZR, serves to form the reversing gear stage VII.

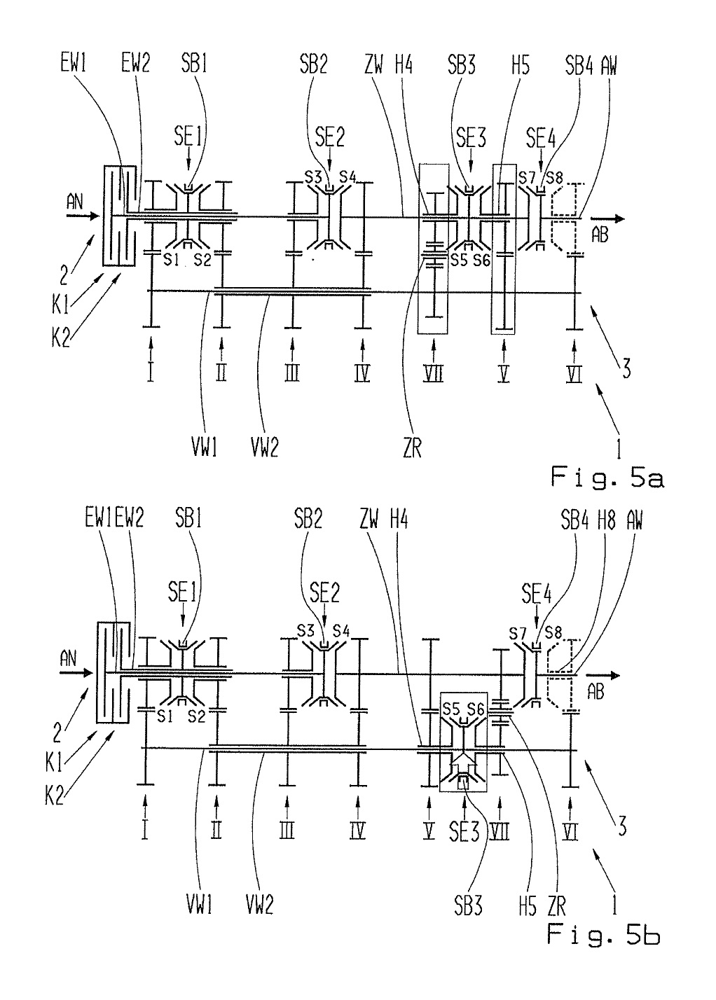

FIG. 5a shows a fifth embodiment of a transmission according to the present invention.

FIG. 5a shows a transmission 1 essentially like that of FIG. 2. Otherwise than in the transmission according to FIG. 2 and analogously to the modification of the transmission of FIG. 1 shown in FIG. 4a, in the transmission according to FIG. 5a the positions of the gearwheel planes V and VII along the main axis 2 and the secondary axis 3 have been swapped. The transmission element of the gearwheel plane VII in the form of the reversing gear stage along the main axis 2 is now connected to the fourth hollow shaft H4, which in turn is connected to the fifth shifting element S5. As also in the transmission according to FIG. 2, the shifting element S5 is connected to the intermediate shaft ZW. The transmission element of the gearwheel plane VIII on the main axis 2, which is connected to the fourth hollow shaft H4 on the main axis 2, co-operates analogously to the transmission of FIG. 2 with a corresponding transmission element on the secondary axis 3, with interposition of an intermediate gearwheel ZR, to produce a reversing gear. As a further difference from the transmission 1 of FIG. 2, the transmission element of the fifth gearwheel plane V is connected to the fifth hollow shaft H5. The fifth hollow shaft H5 is connected to the shifting element S6 and also to the intermediate shaft ZW; so that when the shifting element S6 is actuated torques can be transmitted from the intermediate shaft ZW to the fifth hollow shaft H5. The transmission element on the fifth hollow shaft H5 co-operates with a corresponding transmission element to form the fifth gearwheel plane V on the first countershaft VW1.

FIG. 5b shows a sixth embodiment of a transmission according to the present invention.

FIG. 5b shows a transmission 1 essentially like that according to FIG. 2.

Otherwise than in the transmission 1 of FIG. 2 and analogously to the transmission 1 of FIG. 4b, in the transmission 1 shown in FIG. 5b the third shifting mechanism SE3 is arranged on the secondary axis 3 instead of on the main axis 2. In this case the fourth hollow shaft H4 and the fifth hollow shaft H5 are arranged coaxially with the first countershaft VW1. The fourth hollow shaft H4 has a transmission element which co-operates with a transmission element on the intermediate shaft ZW on the main axis 2 to transmit torques. The hollow shaft H5 is connected to the shifting element S5 and in turn the shifting element S5 is connected to the countershaft VW1. Analogously, a transmission element is arranged on the fifth hollow shaft H5. The fifth hollow shaft H5 is connected to the sixth shifting element S6, and the sixth shifting element S6 is connected to the countershaft VW1. The transmission element on the fifth hollow shaft H5 co-operates with a corresponding transmission element on the intermediate shaft ZW, with interposition of an intermediate gearwheel ZR, to form the reversing gear stage VII. Thus, the intermediate shaft ZW is connected to the fourth shifting element S4 and to the seventh shifting element S7, so that between the fourth and seventh shifting elements S4, S7 there are arranged three transmission elements, corresponding to the gearwheel planes IV, V and VII.

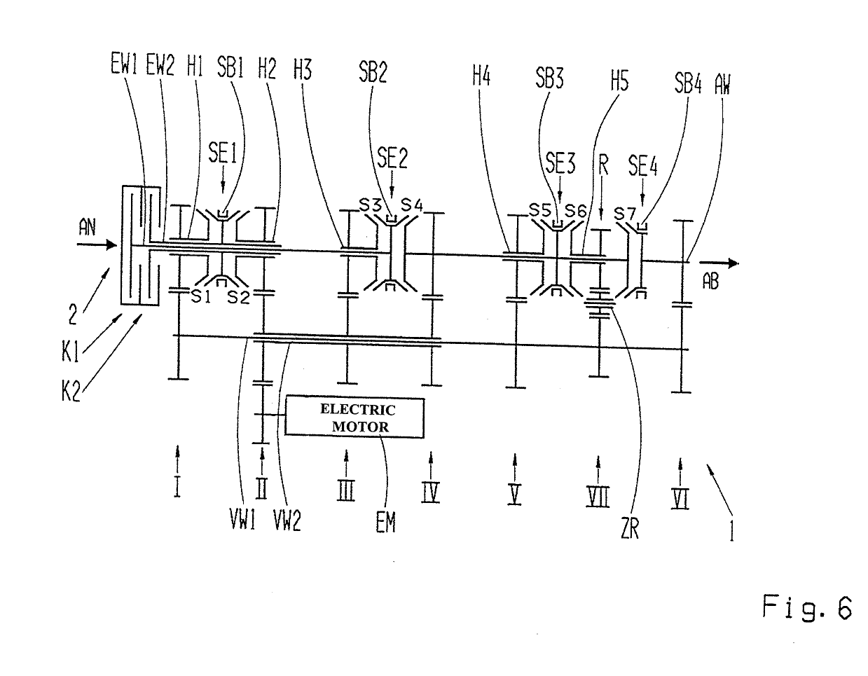

FIG. 6 shows a seventh embodiment of a transmission according to the present invention.

FIG. 6 shows a transmission 1 like that of FIG. 1. The difference from the transmission 1 of FIG. 1 is that the transmission 1 according to FIG. 6 comprises an electric machine EM. For hybridization, the electric machine EM is connected by way of a transmission element to the transmission element of the second gearwheel plane II, which is arranged on the second countershaft VW2. The electric machine EM can also be connected to the transmission 1 at gearwheel planes III and IV, more precisely with transmission elements on one of the countershafts VW1, VW2.

All the shifting elements S1, to S7 (N=7) in the transmission 1 according to FIG. 1 and the shifting elements S1 to S8 (N=8) in the transmission 1 of FIG. 2 can also be referred to as coupling devices, and can in particular be designed as synchronizers. The first shifting element S1 is associated with the first gearwheel plane I, the second shifting element S2 with the second gearwheel plane II, the third shifting element S3 with the third gearwheel plane III, the fourth shifting element S4 with the first or second input shaft EW1, EW2 and the intermediate shaft ZW, the fifth shifting element S5 with the fifth gearwheel plane V, the sixth shifting element S6 with the reversing gear stage VII, the seventh shifting element with the intermediate shaft ZW and with the output shaft AB, and in the transmission 1 according to FIG. 2 the eighth shifting element S8 with the sixth gearwheel plane VI. In the transmission 1 according to FIG. 1 the sixth gearwheel plane VI is designed as an output constant.

In summary, the present invention offers the advantage that particularly when all of the N shifting elements or coupling devices are arranged on the main axis, flexible and comfortable power division is made possible by the use of one or more countershafts. Moreover, the invention offers the advantage that by virtue of seven gearwheel planes and at least seven shifting elements, at least six forward gears and two reverse gears are provided. Furthermore, the invention offers the advantage of making it possible in a simple manner to extend a six-gear, direct-drive transmission as in FIG. 1 to form a seven-gear overdrive transmission, by providing a further coupling device or shifting element. Another advantage of the present invention is that only four actuators in the form of shifting mechanisms for actuating the seven or eight shifting elements have to be provided. In addition the invention offers the advantage that the mechanical spread can be reduced by turning the first gear stage. The present invention also has the advantage of good powershifting ability and good hybridization ability, if it is intended to arrange and use the transmission in a hybrid vehicle.

Although the present invention has been described herein with reference to preferred example embodiments, it is not limited to these but can be modified in many ways.

Indexes

| | |
|---|---|
| 1 | Transmission |
| 2 | Main axis |
| 3 | Secondary axis |
| 4 | Intermediate transmission |
| I, II, III, IV, V, VI, VII | Gearwheel planes |
| S1, S2, S3, S4, S5, S6, S7, S8 | Shifting elements |
| SE1, SE2, SE3, SE4 | Shifting devices |
| EW1, EW2 | Input shafts |
| VW1, VW2 | Countershafts |
| H1, H2, H3, H4, H5, H6 | Hollow shafts |
| AB | Drive output |
| AN | Drive input |
| ZW | Intermediate shaft |
| AW | Output shaft |
| ZR | Intermediate gearwheel |
| EM | Electric machine |
| SB1, SB2, SB3, SB4 | Shifting element actuating devices |

1-15. (canceled)

16. A transmission (1) for a motor vehicle, the transmission comprising:
at least two part-transmissions each of which has at least one input shaft (EW1, EW2),
an output shaft (AW) being arranged as a drive output shaft of both the part-transmissions,
at least one of the input shafts (EW1, EW2) and the output shaft being arranged on either a main axis (2) or a secondary axis,
at least one intermediate transmission (4), with at least one countershaft (VW1, VW2), being provided,
the at least one countershaft (VW1, VW2) having an axis (3) parallel to the main axis (2), and
at least one of the input shafts (EW1, EW2) being connected to the output shaft (AW) by at least two gearwheel planes (I, II, III, IV, V, VI, VII) and by at least one shifting element (S1, S2, S3, S4, S5, S6, S7, S8),
wherein a plurality of shifting elements (S1, S2, S3, S4, S5, S6, S7, S8) N in number are provided, with N being an integer that is either larger than or equal to two, and at least N-1 shifting elements (S1, S2, S3, S4, S5, S6, S7, S8) are arranged on the main axis (2).

17. The transmission according to claim 16, wherein an intermediate shaft (ZW) is arranged between the at least one input shaft (EW1, EW2) and the output shaft (AW), which is connectable by at least two shifting elements (S1, S2, S3, S4, S5, S6, S7, S8) to at least one of one of the input shafts (EW1, EW2), the output shaft (AW) and the countershaft (VW1, VW2).

18. The transmission according to claim 16, wherein at least one transmission element of one of the gearwheel planes (I, II, III, IV, V, VI, VII) on at least one input shaft (EW1, EW2) is couplable, by at least one shifting element (S1, S2, S3, S4, S5, S6, S7, S8), to at least one of the input shafts (EW1, EW2).

19. The transmission according to claim 17, wherein at least two gearwheel planes (I, II, III, IV, V, VI, VII) are couplable, to the intermediate shaft (ZW), by at least one shifting element (S1, S2, S3, S4, S5, S6, S7, S8).

20. The transmission according to claim 17, wherein one of the gearwheel planes (I, II, III, IV, V, VI, VII) is an output constant.

21. The transmission according to claim 16, wherein transmission elements of at least one of the gearwheel planes (I, II, III, IV, V, VI, VII) are arranged in a fixed manner on at least one of the countershafts (VW1, VW2).

22. The transmission according to claim 16, wherein at least two countershafts (VW1, VW2) are arranged coaxially with one another, at least one of the countershafts (VW1, VW2) is a solid shaft and at least one other countershaft (VW1, VW2) is a hollow shaft.

23. The transmission according to claim 21, wherein the transmission elements of at least one of the gearwheel planes (I, II, III, IV, V, VI, VII) are fixedly connected to the hollow shaft.

24. The transmission according to claim 16, wherein at least one gearwheel plane is a reversing gear stage (VII).

25. The transmission according to claim 24, wherein the reversing gear stage (VII) is arranged between two shifting elements (S1, S2, S3, S4, S5, S6, S7, S8) on the intermediate shaft (ZW).

26. The transmission according to claim 21, wherein the shifting element (S6), for actuating the reversing gear stage (VII), is arranged on the secondary axis (3).

27. The transmission according to claim 16, wherein an electric machine (EM) is at least one of arranged on at least one gearwheel plane (I, II, III, IV, V, VI, VII), a countershaft (VW1, VW2) and an input shaft (EW1, EW2) to hybridize the transmission.

28. The transmission according to claim 27, wherein the electric machine (EM) is arranged on one of the gearwheel planes (II) positioned between two shifting elements (S2, S3).

29. The transmission according to claim 16, wherein at least one of the N shifting elements (S1, S2, S3, S4, S5, S6, S7, S8) and the at least two gearwheel planes (I, II, III, IV, V, VI, VII) are arranged such that at least 6 forward gears (I, II, III, IV, V, VI,) and at least two reverse gears (VIII) are implementable by the transmission (1).

30. The transmission according to claim 16, wherein shifting element actuating devices (SB1, SB2, SB3, SB4) are provided for actuating the N shifting elements (S1, S2, S3, S4, S5, S6, S7, S8), and the number of shifting element actuating devices (SB1, SB2, SB3, SB4) being at least ^{└}N/2^{┘}+1.

31. The transmission according to claim 16, wherein at least one of the N shifting elements (S1, S2, S3, S4, S5, S6, S7, S8) and the at least two gearwheel planes (I, II, III, IV, V, VI, VII) are arranged such that at least 7 forward gears (I, II, III, IV, V, VI,) and at least two reverse gears (VIII) are implementable by the transmission (1).

32. A dual clutch transmission for a motor vehicle, the transmission comprising:
at least two part-transmissions each of which having at least one input shaft (EW1, EW2),
an output shaft (AW) being arranged as a drive output shaft of both of the at least two part-transmissions,
at least one of the input shafts (EW1, EW2) and the output shaft being arranged on one of a main axis (2) or a secondary axis,
at least one intermediate transmission (4), with at least one countershaft (VW1, VW2),
the at least one countershaft (VW1, VW2) having an axis (3) that is parallel to the main axis (2),
at least one of the input shafts (EW1, EW2) is connectable to the output shaft (AW) by at least one of at least two gearwheel planes (I, II, III, IV, V, VI, VII) and at least one of a first quantity of shifting element (S1, S2, S3, S4, S5, S6, S7, S8),
the first quantity of the shifting elements (S1, S2, S3, S4, S5, S6, S7, S8) being either larger than or equal to two, and a second quantity of the shifting elements (S1, S2, S3, S4, S5, S6, S7, S8) being arranged on the main axis (2), the second quantity of the shifting elements is one less than the first quantity of the shifting elements.
